(19) United States
(12) Patent Application Publication
(10) Pub. No.: US 2003/0163368 A1
(43) Pub. Date: Aug. 28, 2003

(54) Method for promoting a web site using services of a web site host

(76) Inventor: Frank Bastone, New City, NY (US)

Correspondence Address: Samuel H. Dworetsky, AT&T CORP., P.O. Box 4110, Middletown, NJ, 07748-4110, US

(21) Appl. No.: 09/861,741

(22) Filed: May 21, 2001

(51) Int. Cl. G06F 17/60

(52) U.S. Cl. 705/14

(57) ABSTRACT

A system and method is disclosed for promoting a Web site using other services offered by the ISP (Internet Service Provider) hosting the site. The ISP provides a Web site hosting customer with the ability to offer an incentive to existing or potential customers of other ISP-provided services, so that those customers are motivated to visit and/or participate on the hosted Web site. The ISP thereby provides a Web site hosting customer with the valuable ability to increase site visitor traffic and/or increase e-commerce sales, site member enrollment, advertising revenue, and other desired criteria associated with the hosted site. Generally, a visitor to the Web site may receive a benefit in connection with the incentive-related service when the visitor performs a desired activity on the site such as making a purchase on the Web site or becoming a member of the Web site. The incentive-related service is preferably an Internet access service or a telephone service.

### FIELD OF THE INVENTION

The present invention relates to the fields of Internet services, Web site hosting, and electronic commerce. More particularly, the present invention relates to a system and method of promoting a Web site on the Internet.

### BACKGROUND OF THE INVENTION

An Internet service provider (ISP) is an entity that provides individuals and businesses with access to the Internet. The term ISP generally includes both online service providers that have their own online independent content (such as America Online) and Internet access providers that simply connect a subscriber directly to the Internet. For customers throughout a geographic area, the ISP provides the required equipment and telecommunication line access to establish a point-of-presence or access point to the Internet. Local or regional Internet service providers typically cover specific geographic regions, such as cities or states, whereas larger national ISPs may cover a number of states, an entire country, or even several countries. Most small or regional ISPs depend on the infrastructure of other telecommunication providers to support their service offering, while large ISPs often own or lease their own high-speed data lines so that they are less dependent on third party providers. Furthermore, in addition to providing Internet access services, some of the larger ISPs—for example, AT&T—offer (either directly or through an affiliate) a variety of additional telecommunication services, including local telephone service, long-distance telephone service, and wireless telephone service.

Many ISPs also provide some of their customers with related Internet services such as World Wide Web (Web) site hosting. Due to their size, access to high-speed data connections, and extensive traffic-handling abilities, large ISPs are commonly used to host business Web sites, especially sites used for electronic commerce. As a Web site host, an ISP houses, serves, and maintains files for each hosted site. Furthermore, ISPs, particularly larger ISPs, may have significant individual customer bases and service-offering capacity for telecommunication services such as internet access and telephone service. Consequently, it would be desirable for an ISP to be able to promote the ISP's services and/or generate a commercial opportunity by exploiting both the ISP's individual customer base (along with its potential for expansion) and the ISP's Web site hosting customer base.

### SUMMARY OF THE INVENTION

In the system and method of the present invention, an ISP provides a Web site hosting customer with the ability to offer an incentive to existing or potential recipients of other ISP-provided services, so that those recipients are motivated to visit and/or participate on the hosted Web site. In this manner, the ISP provides a Web site hosting customer with the valuable ability to increase and promote e-commerce sales, site member enrollment, advertising revenue, or other desired criteria associated with the hosted site.

In one aspect, the present invention provides a service provider system for promoting a Web site comprising a Web site hosting system for hosting a Web site on behalf of a site-hosting customer. The Web site is accessible on the Internet to site visitors. The service provider system also comprises at least one service-offering system for providing an incentive-related service, and Web site visitors are provided with the opportunity to receive a benefit in connection with the incentive-related service. The service provider system further comprises a database for maintaining information specific to recipients of the incentive-related service including, for site visitors who receive a benefit in relation to the service, information relating to the site visitor and the benefit received.

A visitor may receive the benefit in connection with the incentive-related service when the visitor performs a desired activity on the site such as making a purchase on the Web site or becoming a member of the Web site. The incentive-related service may be an Internet access service or a telephone service, for example. The Web site content may also offer a plurality of benefits to site visitors, and a site visitor who becomes entitled to a benefit may be provided with the option of choosing the benefit.

The information maintained in the database preferably comprises an account for each visitor who receives the incentive-related service. Benefits may be provided to both site visitors having an existing account for the incentive-related service and to site visitors wishing to establish a new account for the incentive-related service. The account preferably includes billing information for the incentive-related service, the benefit preferably is a discount or rebate on charges associated with the incentive-related service, and the discount or rebate, when received by the visitor, is preferably automatically applied to the site visitor's account for the incentive-related service.

The site-hosting customer may at least partially compensate the service provider system for a discount or rebate received by a site visitor. In this case, the database preferably further maintains account information relating to the site hosting customer, and the amount by which the site hosting customer compensates the service provider system can, conveniently, be automatically added to the account information for the site hosting customer.

The service provider system may also comprise a plurality of service-offering systems, each providing a different incentive-related service. A site visitor who becomes entitled to a benefit may therefore be provided with the option of choosing the incentive-related service to which the benefit applies. Generally, the incentive-related services can include dial-in Internet access service, high-speed Internet access service, local telephone service, long-distance telephone service, and wireless telephone service.

In another aspect, the present invention provides a Web site accessible on the Internet to site visitors and comprising content offering a benefit to site visitors in connection with an incentive-related service. The Web site is hosted at a location of a hosting service provider, and the incentive-related service is provided by the hosting service provider. The content of the site preferably specifies that a site visitor receives the benefit in connection with the incentive-related service when the visitor performs a desired activity on the Web site.

In still another aspect, the present invention provides a method of promoting a Web site, comprising hosting a Web site on behalf of a site-hosting customer, the Web site being accessible on the Internet to site visitors. The method also includes providing an incentive-related service, wherein site visitors are provided with the opportunity to receive a benefit in connection with the incentive-related service, and maintaining information specific to recipients of the incentive-related service including, for site visitors who receive a benefit in relation to the service, maintaining information relating to the site visitor and the benefit received. The method also preferably comprises offering a site visitor the benefit in connection with the incentive-related service.

### BRIEF DESCRIPTION OF THE DRAWINGS

The objects and advantages of the present invention will be better understood and more readily apparent when considered in conjunction with the following detailed description and accompanying drawings which illustrate, by way of example, preferred embodiments of the invention and in which:

FIG. 1 is a network diagram showing an Internet service provider (ISP) capable of implementing the Web site hosting promotional system and method of the present invention; and

FIG. 2 is a flow chart illustrating the operation of the Web site hosting promotional system and method of the present invention.

### DETAILED DESCRIPTION OF PREFERRED EMBODIMENTS

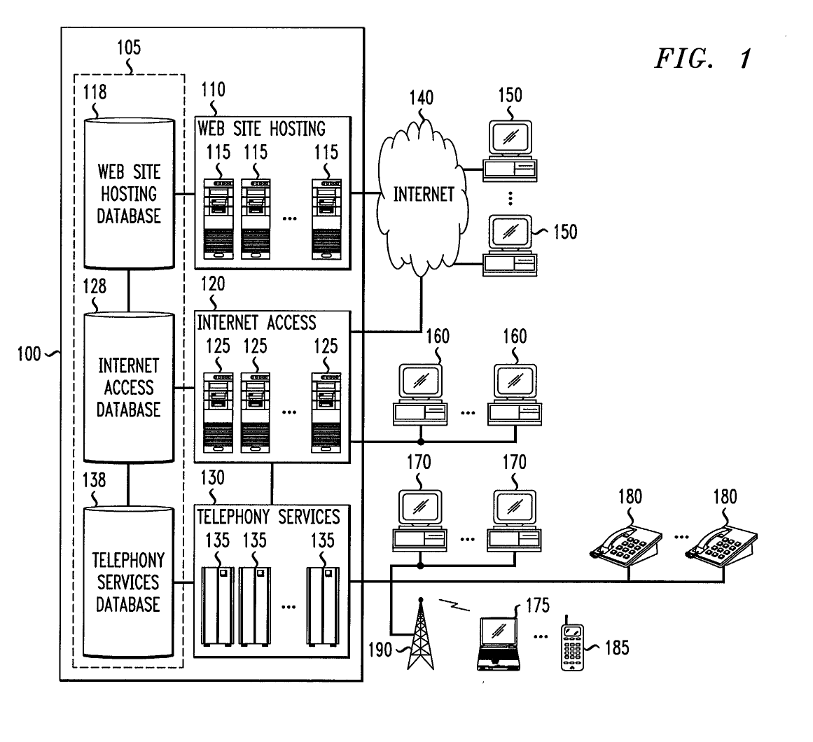

FIG. 1 is a network diagram showing an Internet service provider (ISP) system or organization 100 that provides customers with Web site hosting and Internet access services. ISP 100 may also offer additional services, such as telephony or other telecommunication services. To provide these services, ISP 100 includes: a Web site hosting system 110 comprising a number of Web server computers 115 that are connected to the Internet 140, and thereby to other Internet-connected computers 150; an Internet access system 120 comprising a number of Internet access server computers 125 for connecting computers 160, 170, 175 to the Internet 140; and a telephony services system 130 comprising a number of central or mobile office switching stations 135 for connecting telephones 180 and 185 to the public switch telephone network (PSTN) (not shown) to provide local, long-distance, and/or wireless telephone service. As will be appreciated, Web site hosting system 110, Internet access system 120, and telephony system 130 of 100 may each be spread out geographically over a number of different locations.

ISP 100 also maintains a database of information relating to the recipients of the services provided by each of systems 110, 120, and 130. In the illustrated embodiment of FIG. 1, ISP 100 maintains a database system 105 having a web site hosting database component 118, an Internet access database component 128, and a telephony services database component 138. As shown in FIG. 1, database components 118, 128, and 138 are linked to one another; however it will be appreciated by those skilled in the art that recipient- and service-related data for ISP 100 may be partitioned or maintained in various different manners. For example, a single integrated database may be maintained for the entire ISP system 100, or a separate database may be maintained at each geographic location of systems 110, 120, and 130.

As shown in FIG. 1, services provided by telephony system 130 of ISP 100 (or similar services provided by other telephone service providers) may connect computers 170 and 175 to Internet access system 120, using a conventional telephone network connection or a faster digital subscriber line (DSL) connection. Typically, mobile computers 175 and wireless telephones 185 connect to a switching station 135 by way of an antenna base station 190 operated by telephony system 130. Although only one mobile computer 175 and one wireless telephone 185 are shown in FIG. 1, this is merely for the sake of clarity and, in general, multiple mobile computers 175, wireless telephones 185, and other portable devices (such as personal digital assistants) may be serviced by system 130.

In known manner, Web site hosting system 110 includes a number of Web server computers 115 that are connected to the Internet 140 and house, serve, and maintain files for the Web site's customers. From the customer's perspective, site hosting by ISP 100 is desirable since: the customer does not have to purchase and maintain its own Web server host with a connection to the Internet 140; ISP 100 typically has access to a fast connection for serving files on the Internet 140; and there is no security risk that would arise from having a Web server on the customer's own network. In addition to Web site hosting, system 110 may also provide customers with services relating to domain name registration, multiple domain name mapping, allocation of file storage and directory setup for Web site files, e-mail addresses, and Web site design. A shared Web server computer 115, assigned an Internet Protocol (IP) number, hosts a number of different customer Web sites or domains where each domain name points to a different set of files in the Web server computer's file system. Alternatively, especially for sites with significant traffic, system 110 may dedicate a Web server computer 115 to a single customer domain, so that the server computer 115 only serves traffic for the Web site associated with that domain. Customers with a dedicated Web server computer 115 may be provided with additional control of their Web site file system, e-mail names, passwords, and other resources, so that the server 115 effectively acts as a “virtual server” of the customer. As another site hosting alternative, ISP 100 may permit customers who own their own server computers to physically place (or co-locate) those machines at Web site hosting system 110 to lake advantage of ISP 100's high-speed access to the Internet 140. The content of a customer's Web site (i.e., the Web pages) is preferably stored and maintained directly on the Web server 115 designated to serve that site. Generally, to specify content, a customer of Web site hosting system 110 may use a File Transfer Protocol (FTP) program to exchange Web content files with system 110.

Web site hosting database component 118 preferably maintains information relating to each hosted customer's account such as the customer's name, contact details, account number, account type, and billing charges. In addition, site hosting database component 118 may maintain tracking analysis data and statistics on the number of visitors to the customer's site (e.g., hits or page-views), the visitor's IP address/host, and any details provided by the visitor (e.g., log-in name). For customer Web sites offering products or services for sale, i.e., electronic commerce or e-commerce sites, database component 118 preferably contains records of sales transactions, a catalog or store database of product/service descriptions, inventories, and customer profiles. Web site hosting system 100 also preferably supports real-time credit and/or debit card processing so that products and services can be sold directly to site visitors on-line, and taxes and shipping calculations can be automatically added to customers' orders. Web site hosting system 100 may also offer customers a hosting option wherein ISP 100 hosts add on e-commerce functionality, such as credit card processing, for a site that is hosted at a location other than at system 110.

Referring still to FIG. 1, Internet access system 120 includes a number of Internet access server computers 125 that provide service-recipient computer systems with a point of presence on the Internet 140. Some service-recipient computers 160 may connect directly to an access server computer 125 in system 120, for example using a cable Internet connection or an ISDN connection. Other service-recipient computers 170 and mobile computers 175 connect to Internet access system 120 through a telephone service provider, such as telephony service system 130. For instance, a computer 170 may, using an analog modem, dial-in to a telephone number associated with Internet access system 120; this telephone call is routed by a switching station of the local telephone service provider (and if necessary, by a long-distance telephone service provider) into the public switched telephone network before connecting to Internet access system 120. Alternatively, if a computer 170 has access to a digital subscriber line (DSL) connection to the local telephone service provider's switching station, the connection is routed from the switching station to Internet access system 120. Also, an office switching station 135 and an Internet access server 125 that are run by ISP 100 may both be situated at the same station location.

Internet access service database component 128 preferably contains account information relating to the account of each recipient (or customer) of the Internet access provided by ISP organization 100, such as the recipient's name, contact details, e-mail address, account number/identifier, account type, and billing information and charges.

As indicated, ISP 100 preferably offers additional services, particularly telecommunication services, such as the telephone services provided by system 130 in FIG. 1. In known manner, telephony services system 130 comprises a number of switching stations 135 for connecting telephone service recipients to the public switch telephone network or PSTN (not shown). Wired (e.g., residential) telephone service accounts may be provided with local and/or long-distance telephone service by system 130, and typically the service-recipient is connected to a station 135 located near the recipient's residence (or other establishment). It will be appreciated that one or more of the switching stations 135 may alternatively comprise a cable system head-end that connects to service-recipient telephones using voice-over-IP cable technology, and the cable head-end may thereafter connect a telephone to a packet-switched telephony communication network, such as the Internet.

In known manner, local telephone service may also include various accessory services such as caller identification, call messaging, call waiting, call forwarding, and other similar service features. Mobile telephone accounts 185 are provided with wireless telephone service by telephony services system 130, which generally includes service for both local and long-distance telephone calls. As described above, system 130 may also be used to provide Internet access for wireless Internet-enabled devices such as portable computer 175 or wireless telephone 185.

Telephony services database component 138 contains account information relating to recipients or customers) of the particular telephone service(s) provided by ISP organization 100. In particular, database component 138 preferably maintains data on the telephone service recipient's name, contact details, account number (e.g., telephone number), account type or plan, call accessory features subscribed to, and billing information and charges.

In accordance with the present invention, ISP 100 offers Web site hosting customers the ability to offer an incentive to existing or potential recipients (i.e., customers) of other services of ISP 100 to encourage visitation of and participation on a site hosted by ISP 100. The incentive preferably takes the form of a discount, rebate, or other type of benefit in connection with the charges to a customer of ISP 100's Internet access service, local telephone service, long-distance telephone service, wireless telephone service, or other product or service offered by ISP 100. Entitlement to the discount, rebate, or other benefit in connection with the incentive-related service is preferably granted to a site visitor when the site visitor participates on the site in some desired manner. For example, to become entitled to a benefit the visitor may be required to buy a product or service electronically over the web site, complete an on-line survey on the site, enter specific information to become a registered member of the site, or perform some other desired activity on the site.

For example, those with existing customer accounts for ISP 100's Internet access service may be offered a fixed dollar rebate on the customer's next bill for that service if the customer purchases a product on a particular site hosted by ISP 100. Similarly, a Web site hosted by ISP 100 may offer a 50% discount on long-distance telephone charges for a month to those with existing long-distance telephone service accounts with ISP organization 100 when they become registered members of the site. As another example, site visitors having local telephone customer accounts with ISP 100 may be offered free call waiting for a month if they fill out an on-line survey. As will be appreciated, the incentive or benefit offered to existing customers may take many other different forms.

Conveniently, information specific to a site visitor such as name, address, and an account identifier (e.g., a telephone number or e-mail address) may be gathered by the Web site for each visitor granted a discount, rebate, or other type of benefit in accordance with applicable privacy restrictions available to each site visitor. Typically, the site visitor is prompted to enter this information when, for example, making a purchase on or becoming a member of the Web site. Alternatively, the site visitor may be separately prompted to enter this information in connection with receiving a benefit for the incentive-related service. The visitor-specific and benefit information are maintained in system database 105. In one embodiment, this information is initially logged in Web site hosting database component 118 and then transferred to a linked database component for maintaining information on the incentive-related service of ISP 100, for instance Internet access database component 128 or telephony services database component 138. Alternatively, visitor-specific and benefit information may be logged in an integrated database for customers of all services offered by ISP 100. Regardless of how this information is logged by ISP 100, the benefit is preferably applied automatically to the service recipient's existing customer account, without requiring further participation by either the service recipient or the Web site granting the customer the benefit.

In a similar manner, an incentive may also be offered to potential recipients or customers of a service offered by ISP organization 100. Note that a potential customer of an incentive-related service offered by ISP 100 may already be a recipient of other services of ISP 100. For instance, a service recipient who already has an existing local and long-distance telephone customer account may be considered a potential customer for a wireless telephone service or for a specific accessory feature (such as call-waiting). Similarly, an existing dial-in Internet access customer may be considered a potential customer for high-speed (i.e., faster than a dial-in telephone connection using an analog modem) Internet access, such as DSL or cable. For potential customers, the incentive may take the form of a discount on the set-up or initial costs typically incurred by new customers of the service. For example, the incentive may comprise a hardware or installation fee waiver when setting up a new high-speed Internet access account with ISP 100. As another example, the incentive may be a fixed discount on a new wireless telephone when subscribing to a wireless telephone service from ISP 100. Again, it will be appreciated that the incentive or benefit offered to potential customers may take any desired form.

Typically, for site visitors who are only potential customers of an incentive related service of ISP 100, no service recipient specific information is yet maintained in database system 105 in connection with that service. In a preferred embodiment, after a potential customer for an incentive-related service visits a Web site hosted by system 110 of ISP 100 and becomes entitled to a benefit, the potential customer is provided with a link to ISP 100's own service-ordering Web site or to a service-ordering page or frame within the hosted Web site. At ISP 100's service-ordering Web site (or at the designated page or frame of the hosted site), the customer is invited to order the new service and automatically collect or claim the benefit that the customer is entitled to. Again, visitor-specific information may be gathered initially by the hosted Web site or independently at ISP 100's service-ordering Web site, subject to the privacy considerations discussed previously. Preferably, if the visitor becomes a new recipient of an incentive-related service, the benefit is automatically applied to the new account, and the visitor-specific information along with information relating to the benefit provided to the visitor is logged in ISP database system 105.

Alternatively, after becoming entitled to a benefit while visiting a site hosted by ISP 100, a potential customer may be provided with an option to have ISP 100 contact the potential customer directly, at which time the customer will be entitled to that benefit if a new service is established. In this embodiment, a representative of ISP 100 may contact the customer by telephone, e-mail, mail, or other suitable means using contact information entered by the customer while visiting the site hosted by system 110.

By offering a Web site hosting customer of system 110 the option or ability to offer incentives to users of other services to visit the hosted site, ISP organization 100 provides the Web site hosting customer with the ability to increase site visitor traffic with respect to both existing and potential recipients of other services offered by ISP organization 100. By increasing traffic, the Web site hosting customer may increase e-commerce sales, site member enrollment, advertising revenue, and other desired criteria associated with the Web site hosting customer's site. As a result, ISP 100 may require that a Web site hosting customer who offers such incentives fully or partially compensate ISP 100 for the benefits claimed by visitors to the Web site hosting customer's site. Where the incentive offering capability is particularly attractive to Web site hosting customers, ISP 100 may further charge a premium over and above the value of any benefits claimed. Alternatively, ISP 100 may simply allow Web site hosting customers the option of offering incentives for other services of ISP 100 as a mechanism to promote ISP 100's own web hosting service. This may be more acceptable to ISP 100 in the case of potential/new customers of ISP services, since ISP 100 generally increases its customer base with respect to the incentive-related service when benefits are claimed by such site visitors.

It will also be appreciated that the nature of the incentives offered to existing or potential service recipients of ISP 100 on a site hosted by system 110 of ISP 100 may vary from site to site and service to service. In addition, a hosted site may offer a number of different benefits to existing or potential recipients of ISP 100 services, and a Web site visitor may be permitted to select the benefit that the visitor is most interested in. For instance, the visitor's benefit selection may be based on the services that ISP 100 currently provides to that visitor or on new services that the visitor may be interested in receiving from ISP 100.

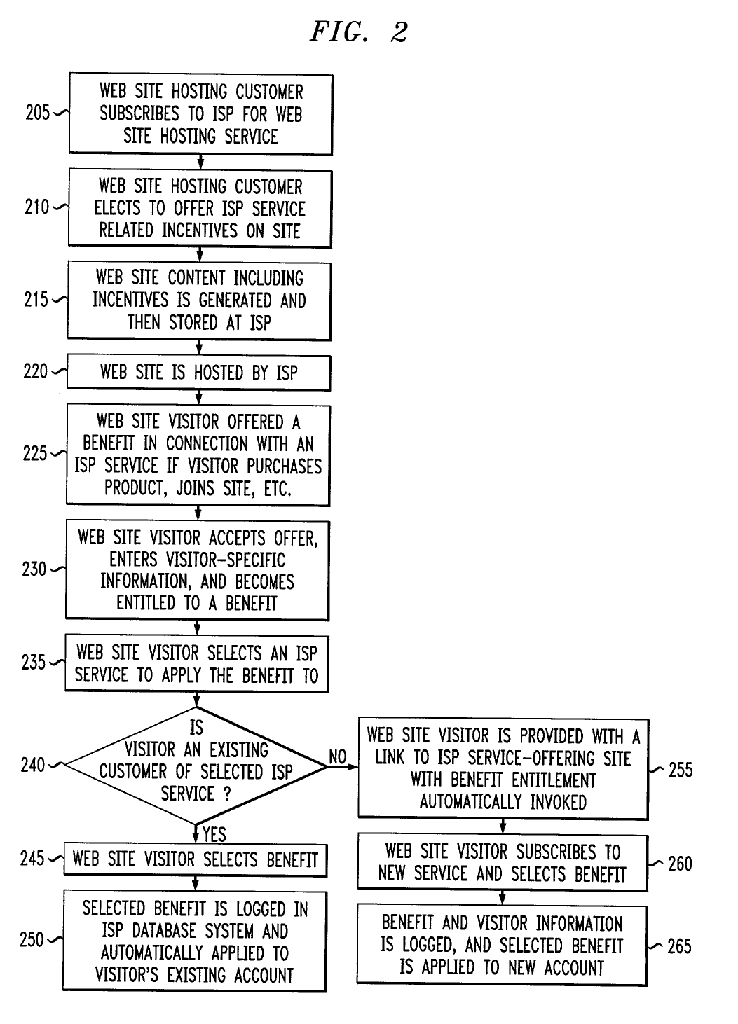

FIG. 2 is a flow chart illustrating the main operational steps of the Web site hosting promotional system and method in a preferred embodiment of the present invention. As shown at step 205, a Web site hosting customer of system 110 initially subscribes to the Web site hosting service offered by ISP 100. Typically, the Web site hosting customer is a business that intends to use its Web site for commercial purposes such as e-commerce or advertising. At step 210, the Web site hosting customer elects to provide incentives to visit the site by offering visitors benefits related to other services provided by ISP 100. As indicated, the option to offer these benefits as incentives may be provided to new or existing Web site hosting customers of ISP 100 in return for a premium fee and/or some type of compensatory arrangement between ISP 100 and the Web site hosting customer. Alternatively, ISP 100 may promote its Web site hosting service by giving all customers whose site is being hosted the option to use such incentives. As described above, the nature of the incentive benefits offered by the hosted Web site may vary and relate to various different services offered by ISP 100. In addition, a site may also allow a visitor to choose from a number of incentive benefits based on the type of service and/or nature of the benefit.

Referring still to FIG. 2, at step 215 the Web site content including incentive offerings is generated and stored on a Web hosting server 115 in system 110. Existing Web site content may alternatively be transferred to system 110 and thereafter combined with incentive offering content. The site, hosted by ISP system 110, is then connected to the Internet 140 and thereby to potential site visitor computers 150, as shown at step 220. Incentive-related content on the hosted Web site generally comprises at least an announcement on one or more Web pages of the hosted Web site and prompted data entry fields for the visitor to enter visitor-specific information. As shown at step 225, the incentive benefit announcements convey to a Web site visitor that, if the visitor buys a product/service, joins the site as a member, or performs some other desired task on the site, the customer will be provided with a benefit in connection with a new or existing ISP 100-related service offering. At step 230, when a visitor accepts the incentive benefit offer (i.e., by buying a product/service from the site, joining the site as a member, or performing some other desired task on the site), the visitor enters visitor-specific information such as the visitor's name, address, e-mail address, telephone number, and whether the visitor is already a customer of a service (or services) offered by ISP 100 in prompted data entry fields. The visitor is then entitled to receive or claim the benefit, or one of the possible benefits, specified by the site.

Where the benefit-entitled Web site visitor has the option of selecting the ISP 100 service for which the visitor wishes to receive a benefit, the visitor may then select at step 235 the desired ISP service—e.g., dial-in Internet access, high-speed Internet access, local telephone service, long-distance telephone service, or wireless telephone service—to which to apply the benefit. By comparing the visitor-specific data entered by the site visitor with information in the database component for the ISP service, ISP 100 can determine whether the Web site visitor is an existing customer of that service, as shown at step 240. The visitor may then be prompted to select a specific benefit (if a choice is offered) at step 245, and, thereafter, the benefit and visitor-specific information is logged in ISP database system 105 and automatically applied to the existing account of the visitor, as shown at step 250. Preferably, the benefit and visitor-specific information is stored in a database component corresponding to the ISP 100 incentive-related service.

If, at step 240, ISP 100 determines that the selected service would be a new service offering for the visitor, the visitor (i.e., the visitor's Web client software) is preferably provided with a link to a related service-offering site of ISP organization 100, as shown at step 255. As an alternative, the link may simply open up a new page or frame within the same Web site hosting customer's site, or the visitor may be provided with an option to have a representative of ISP 100 contact the visitor by telephone or e-mail. If the visitor follows the link, the benefit entitlement of the visitor is preferably invoked automatically during a service set-up process, as also shown at step 255. At step 260, the visitor subscribes to the new service by entering visitor-specific information and selecting the desired benefit (if a choice is offered). At step 265, the benefit and visitor-specific information is logged in ISP database system 105, and the selected benefit is automatically applied to the newly set-up account. Again, the benefit and visitor-specific information is preferably stored in a database component corresponding to the ISP 100 service.

In another embodiment, where the Web site hosting customer fully or partially compensates ISP 100 for benefits granted to site visitors, the amount of compensation can also be automatically added to the billing information in database component 118 for the Web site hosting customer.

While the invention has been described in conjunction with specific embodiments, it is evident that numerous alternatives, modifications, and variations will be apparent to those skilled in the art in light of the foregoing description.

What is claimed is:

1. A method of promoting a Web site comprising:
hosting a Web site for access on the Internet to site visitors;
providing an incentive-related service, wherein site visitors are provided with an opportunity to receive a benefit in connection with the incentive-related service; and
maintaining information specific to recipients of the incentive-related service including, for site visitors who receive a benefit in connection with the service, information relating to the site visitor and the benefit received.

2. The method of claim 1 further comprising offering a site visitor the benefit in connection with the incentive-related service.

3. The method of claim 1 comprising providing the benefit to a site visitor when the visitor performs a desired activity on the site.

4. The method of claim 3 wherein the visitor performs the desired activity when the visitor makes a purchase on the Web site.

5. The method of claim 3 wherein the visitor performs the desired activity when the visitor registers as a member of the Web site.

6. The method of claim 1 wherein providing an incentive-related service comprises providing an Internet access service.

7. The method of claim 1 wherein providing an incentive-related service comprises providing a telephone service.

8. The method of claim 1 comprising generating incentive-related content for the Web site, the incentive-related content comprising content offering the benefit to site visitors.

9. The method of claim 8 wherein the incentive-related content comprises content offering a plurality of benefits to site visitors, and further comprising providing a site visitor who becomes entitled to a benefit with the option of choosing the benefit.

10. The method of claim 1 wherein maintaining information specific to recipients of the incentive-related service comprises maintaining a customer account for the incentive-related service.

11. The method of claim 10 further comprising collecting visitor-specific information from site visitors entitled to receive a benefit in connection with the incentive-related service, and determining whether the site visitor is an existing customer of the incentive-related service.

12. The method of claim 11 further comprising, when the site visitor is not an existing customer of the incentive-related service, creating for the site visitor a customer account for the incentive-related service.

13. The method of claim 12 wherein creating the site visitor's customer account includes linking the customer to a separate designated service-offering Web site for ordering the incentive-related service.

14. The method of claim 12 wherein creating the site visitor's customer account includes linking the customer to a designated service-offering page or frame, within the Web site, for ordering the incentive-related service.

15. The method of claim 12 wherein creating the site visitor's customer account includes providing the customer with an option to have a representative for the incentive-related service contact the customer.

16. The method of claim 10 wherein the customer account includes billing information for the incentive-related service and the benefit is a discount or rebate on charges associated with the incentive-related service, and the method further comprises automatically applying a discount or rebate, when received by the visitor, to the site visitor's customer account for the incentive-related service

17. The method of claim 16 further comprising receiving from the site hosting customer at least partial compensation for a discount or rebate received by the site visitor.

18. The method of claim 17 further comprising maintaining account information relating to the site hosting customer, and automatically adding the at least partial compensation for a discount or rebate to the account information for the site hosting customer.

19. The method of claim 1 comprising providing a plurality of incentive-related services to customers.

20. The method of claim 19 further comprising providing a site visitor who becomes entitled to a benefit with the option of choosing the incentive-related service to which the benefit applies.

21. The method of claim 20 wherein providing a plurality of incentive-related services to customers comprises providing at least two of the following: dial-in Internet access service, high-speed Internet access service, local telephone service, long-distance telephone service, and wireless telephone service.
